(19) United States
(12) Patent Application Publication
(10) Pub. No.: US 2020/0269534 A1
(43) Pub. Date: Aug. 27, 2020

(54) TIRE WITH PRE-FORMED RIBBON TREAD AND METHOD OF MAKING SAME

(71) Applicant: Bridgestone Americas Tire Operations, LLC, Nashville, TN (US)

(72) Inventors: William L. LUTES, Franklin, TN (US); Randall L. EVANS, Franklin, TN (US)

(21) Appl. No.: 16/066,203

(22) PCT Filed: Dec. 20, 2016
(86) PCT No.: PCT/US2016/067667

§ 371 Date: Jun. 26, 2018

Related U.S. Application Data
(60) Provisional application No. 62/272,868, filed on Dec. 30, 2015.

(51) Int. Cl. B29D 30/60; B29C 48/07; B29C 48/35; B29C 48/92

(52) U.S. Cl. CPC B29D 30/60; B29C 48/07; B29C 48/35; B60C 2011/0091; B29C 2948/92571; B29C 2948/9259; B29C 2948/926; B29C 48/92

(57) ABSTRACT

A system for making a tire tread includes an extruder, a roller die having a first axis of rotation, and a conveyor that receives a round strip (or noodle) of green rubber from the extruder and feeds the strip of green rubber to the roller die. The system further includes a drum having a second axis of rotation, wherein the roller die is configured to apply the strip of green rubber to the drum. The system also includes a controller, wherein the controller is configured to control a translation of the roller die in a first direction parallel to the first axis of rotation. The controller is configured to control a roller die rotation speed and a drum rotation speed, and the controller varies at least one of the roller die rotation speed and the drum rotation speed during translation of the roller die.

### FIELD OF INVENTION

This disclosure relates to the field of tire constructions and methods of tire construction. More particularly, the disclosure relates to tires with features such as lugs, bars, ribs, or tread blocks, and methods of making tires with these features. Further, the disclosure also describes agricultural and off road tires and methods of making agricultural and off road tires.

### BACKGROUND

Known tire manufacturing methods involve building a green tire, including a green tread, and vulcanizing the green tire and tread in a mold. The tread may be built by a ribbon treading process, in which a ribbon of green rubber is continuously applied in a spiral manner to a drum. When a green tire is placed in a mold, the volume between the green tire and the mold features must be filled with rubber. Thus, viscous rubber flows into the volume between the green tire and the mold features. The viscous rubber and green tire are cured during vulcanization.

### SUMMARY OF THE INVENTION

In one embodiment, a method of manufacturing a tire tread includes extruding a rubber strip and conveying the rubber strip to a roller die that rotates about a roller die axis. The method further includes applying the rubber strip from the roller die onto a drum that rotates about a drum axis. The drum axis is substantially parallel to the roller die axis. The method also includes translating the roller die in a first direction parallel to the roller die axis while applying the rubber strip, thereby forming a spiral of the rubber strip about the drum. The method further includes varying a rotation speed of at least one of the roller die and the drum while translating the roller die, thereby creating positive or negative stretch in the rubber strip such that peaks and valleys are formed in the spiral of the rubber strip about the drum.

In another embodiment, a system for making a tire tread includes an extruder, a roller die having a first axis of rotation, and a conveyor having a first end proximate to the extruder and a second end proximate to the roller die, such that it receives a strip of green rubber extruded by the extruder and feeds the strip of green rubber to the roller die. The system further includes a drum having a second axis of rotation, wherein the roller die is configured to apply the strip of green rubber to the drum. The system also includes a controller, wherein the controller is configured to control a translation of the roller die in a first direction parallel to the first axis of rotation. The controller is configured to control a roller die rotation speed and a drum rotation speed, and the controller varies at least one of the roller die rotation speed and the drum rotation speed during translation of the roller die.

In yet another embodiment, a green tire tread includes a strip of green rubber having a first edge and a second edge. The strip of green rubber is wound about in a spiral, such that the first edge overlaps the second edge. A thickness of the strip of green rubber varies along the strip, such that the strip of green rubber has peaks and valleys. A first peak on a first portion of the strip of green rubber is adjacent a second peak on a second portion of the strip of green rubber that overlaps the first portion. A first valley on a third portion of the strip of green rubber is adjacent a second valley on a fourth portion of the strip of green rubber that overlaps the third portion.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a schematic drawing illustrating a side view of one embodiment of a system 100 for making a tire tread;

FIG. 1A is schematic drawing of a detail view of a roller die in the system 100 for making a tire tread;

FIG. 2 is a partial perspective view of a prior art version of a tire tread strip that is spiral wound about a drum;

FIG. 3 is a partial perspective view of an exemplary embodiment of a tire tread strip that is spiral wound about a drum such that the tread strip has peaks and valleys; and

FIG. 4 is a top plan view of an exemplary tread design of a tire.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Axial” and “axially” refer to a direction that is parallel to the axis of rotation of a tire.

“Circumferential” and “circumferentially” refer to a direction extending along the perimeter of the surface of the tread perpendicular to the axial direction.

“Equatorial plane” refers to the plane that is perpendicular to the tire's axis of rotation and passes through the center of the tire's tread.

“Radial” and “radially” refer to a direction perpendicular to the axis of rotation of a tire.

“Tread” as used herein, refers to that portion of the tire that comes into contact with the road or ground under normal inflation and load.

While similar terms used in the following descriptions describe common tire components, it is understood that because the terms carry slightly different connotations, one of ordinary skill in the art would not consider any one of the following terms to be purely interchangeable with another term used to describe a common tire component.

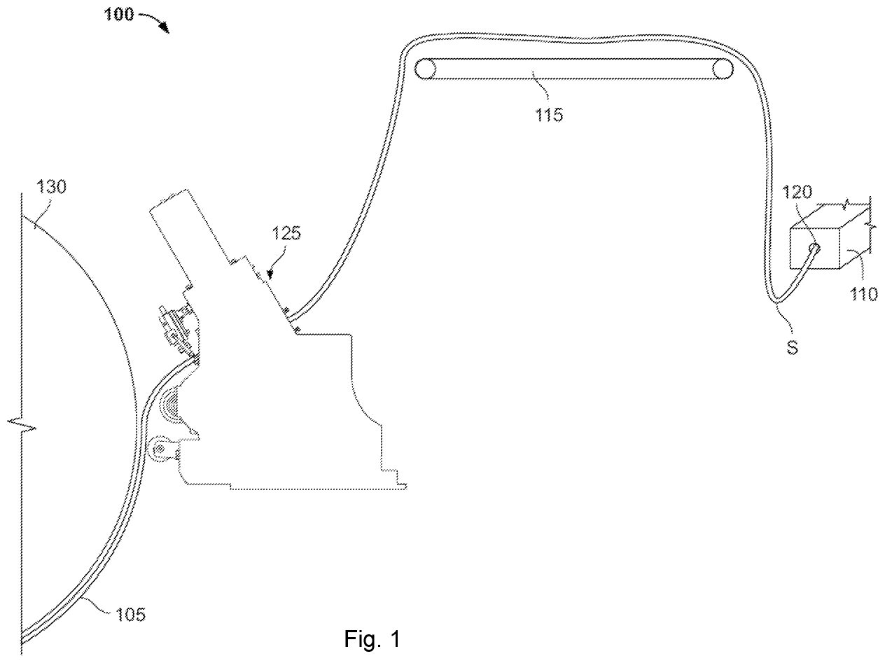

FIG. 1 is a schematic drawing illustrating a side view of one embodiment of a system 100 for making a green tread 105. The system 100 includes an extruder 110 configured to receive a mixture of green rubber and eject it as a strip S onto a conveyor 115. As one of ordinary skill in the art would understand, green rubber is rubber that has yet to be vulcanized. The system 100 is not limited to processing green rubber, however, and any polymeric material may be employed.

The extruder 110 has an opening 120 that defines the shape of the extruded strip S. Here, the opening 120 is round, so the resulting strip S has a circular or rounded cross-section. Such a rounded strip may also be referred to as a round ribbon or a round noodle. In alternative embodiments, the strip may have a rectangular, trapezoidal, triangular, or pentagonal, cross-section when it is extruded. In other alternative embodiments, the cross-section of the strip may be any geometric shape. The shape of the strip may be defined by a die plate that imparts a shape on the ribbon. Alternatively, the strip may be shaped by rollers as it is extruded.

The conveyor 115 has a first end proximate to the extruder 110 to receive the extruded strip S. The conveyor 115 is made of an inextensible material, such as polyester. Because the extrusion process warms the rubber, the strip S is tacky and sticks well against conveyor 115 without the need for adhesives. For example, in one known embodiment the temperature of the rubber is approximately 200° F. (93° C.). However, it should be understood that the rubber may be at any temperature. In an alternative embodiment, at least one side of the conveyor is coated with an adhesive or a resin to obtain proper adhesion to the green rubber strip.

In alternative embodiments (not shown), there may be loop points between the extruder and the conveyor entrance. Likewise, there may be loop points between the conveyor exit and the calendar/roller die entrance. Such loop points may include a series of rollers (not shown) that define a meandering path for the strip S.

The conveyor 115 then feeds the strip of green rubber to a roller die 125, which shapes the strip S and applies it onto a drum 130. Additional details of the roller die 125 are shown in the detail view of FIG. 1A. The roller die 125 includes a pair of shaping rollers 135 that press the round ribbon R into the strip S. In one embodiment, the strip has a rectangular cross-section with a width between 1.5-3.0 inches (3.8-7.6 cm), and a height between 0.25-0.375 inches (0.60-1.0 cm). However, it should be understood that the strip may have any desirable shape with any desirable dimensions.

As can be seen in this view, the strip S is adhered to a bottom surface of the conveyor 120. The conveyor belt 120 loops around a front roller 140 and carried forward by an applicator wheel 140. The rigidity of the strip S causes the strip to continue forward onto the drum 130. In other words, the roller die 125 applies the strip S onto the drum 130. In an alternative embodiment (not shown), separating means such as a knife may be employed to separate the strip from the conveyor surface.

In one embodiment, the applicator wheel 140 is spaced a fixed distance from the drum 130. In an alternative embodiment, the spacing between the applicator wheel 140 and the drum 130 may vary. It may be desirable to position the applicator wheel 140 close to the drum to control the placement of the strip S on the drum 130. For example, the distance between the applicator wheel 140 and the drum 130 may be approximately equal to the height of the strip S (e.g., between 0.25-0.375 inches).

In the illustrated embodiment, the roller die further includes a stitching wheel 145 for pressing the strip S onto the drum 130. The stitching wheel 145 may be connected to a damper that keeps the stitching wheel 145 in consistent contact with the strip S, such that the resulting tread has a smooth surface. The stitching wheel 145 may be coated with a synthetic resin to prevent it from sticking to the strip S. In an alternative embodiment, the stitching wheel may be omitted.

As can be seen in FIGS. 1 and 1A, the applicator wheel 140 has a first axis of rotation and the drum 130 has a second axis of rotation that is substantially parallel to the first axis of rotation. The applicator wheel 140 and the drum 130 rotate in opposite directions, so that the strip is circumferentially wound about the drum 130. For example, in the view shown in FIG. 1A, the drum 130 rotates in a clockwise direction and the applicator wheel 140 rotates in a counter-clockwise direction. In an alternative embodiment, the drum rotates in a counter-clockwise direction and the front roller rotates in a clockwise direction.

The roller die 125 is configured to translate in a first direction parallel to the first axis of rotation while the drum 130 and the applicator wheel 140 each rotate. As a result, the strip S is spiral wound about the drum 130. For example, the roller die 125 may translate along one or more rails that are parallel to the first axis of rotation.

In one embodiment, the roller die 125 translates from a first position to a second position, and then stops. The strip may then be cut to complete the formation of the green tread 105. Such an embodiment may be referred to as a “single pass” embodiment. In an alternative embodiment, the roller die 125 translates from a first position to a second position in a first direction, and then translates from the second position to the first position in a second direction opposite the first direction, applying a second layer of the strip over the first layer. Such an embodiment may be referred to as a “multiple pass” embodiment. It should be understood that in other multiple pass embodiments, the roller die 125 may perform any number of passes. Additionally, the roller die may perform a partial pass. For example, it may be desirable to form thicker shoulder portions of a tire tread.

In another alternative embodiment, multiple roller dies may be employed. In such an embodiment, each roller die may perform a single pass to form a green tread. Alternatively, one or more of the roller dies may perform multiple passes to form multiple layers.

With reference back to FIG. 1, a controller 150 is in signal communication with the conveyor 115, the roller die 125, and the drum 130. The controller 150 is configured to control the speed of the conveyor 115. The controller 150 is also configured to control the translation of the roller die 125 in a direction parallel to its axis of rotation. The controller 150 is further configured to control the rotational speed of the roller die 125 (for example, by controlling the rotational speed of the applicator wheel 140) and the rotational speed of the drum 130. In one embodiment, the applicator wheel 140 is controlled by a timing belt.

The conveyor 115 may be a passive conveyor. In such an embodiment, the controller 150 would control the speed of the conveyor 115 and the rotational speed of the roller die simultaneously by controlling the speed of the timing belt. The controller may be a computer, a PLC, or other controller. While a single controller is shown in the illustrated embodiment, it should be understood that any number of controllers may be employed.

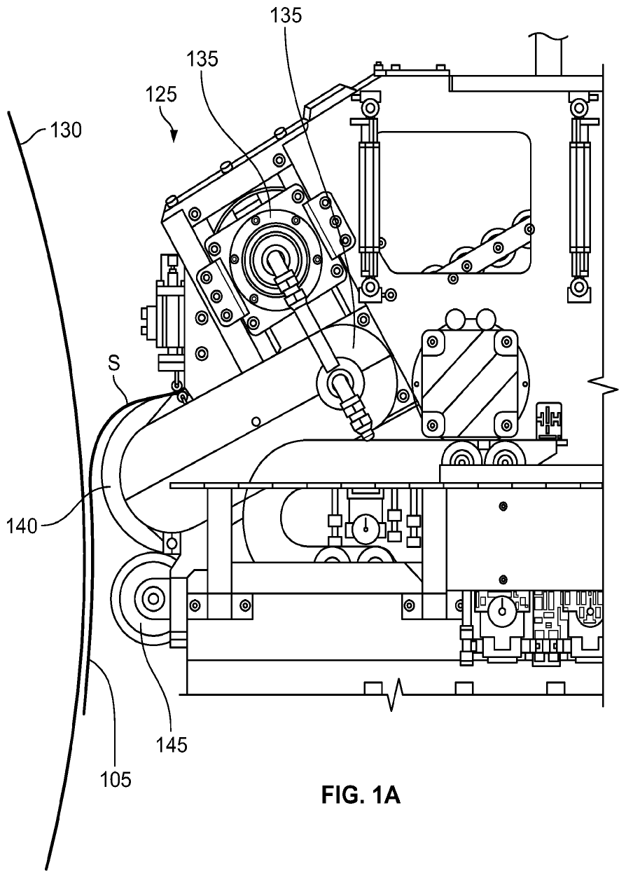

In one embodiment, the controller 150 can control the conveyor speed, the rotational speeds, and the roller die translational speed to produce a smooth, green ribbon tread. Such smooth, green ribbon treads are known in the prior art. An example of a prior art smooth, green ribbon tread is shown in FIG. 2. In this embodiment, a drum 200 holds the smooth, green ribbon tread 205.

In the illustrated embodiment, the drum 200 is a collapsible drum. After the smooth, green ribbon tread 205 is completed, the drum 200 is collapsed so that the smooth, green ribbon tread 205 can be removed and then placed around a tire carcass (not shown) to form a green tire. The tire carcass includes a pair of annular beads configured to secure the tire to a wheel. The tire carcass further includes at least one body ply extending between the annular beads. The tire carcass also includes a circumferential belt configured to provide structural reinforcement to the tire. In general, the tread can be created on a separate belt tread drum, and then transferred to a forming drum where the body package is waiting. Alternatively, the tread can be wound directly onto the forming body package drum when the tire machine is a single drum type system.

The green tire is then placed in a vulcanization mold. The vulcanization mold includes a tread forming portion that imparts tread elements onto the tire. For example, the vulcanization mold may include a tread forming portion for an agricultural tire or off road tire that includes voids for forming lugs (or bars) on the tread, and protrusions for forming valleys between the lugs. During curing of the green tire, rubber flows into voids of the vulcanization mold. High amounts of rubber flow may cause deformation of the circumferential belt. To reduce the amount of rubber that must flow into the voids of the vulcanization mold, certain tread elements, such as bars, lugs, and ribs, may be pre-formed on the green tread.

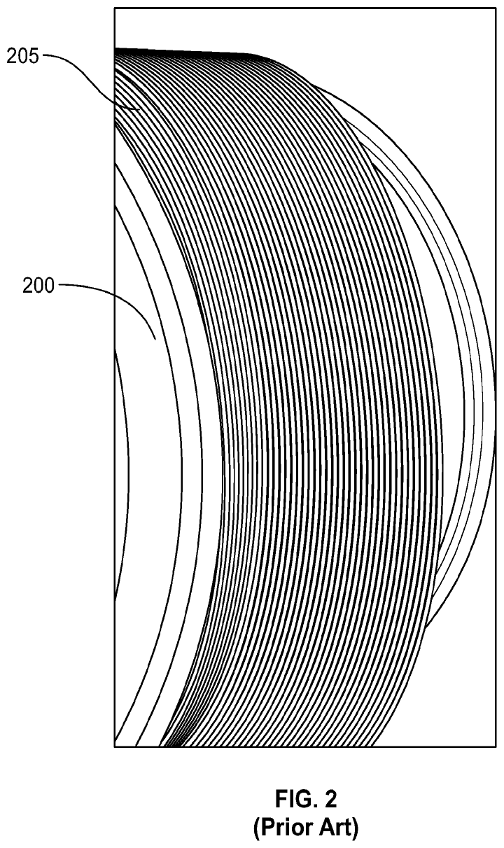

FIG. 3 illustrates another embodiment of a green ribbon tread. In this embodiment, a drum 300 holds a green ribbon tread 305 having pre-formed peaks 310 and valleys 315. The peaks 310 and valleys 315 are formed by the controller 150 varying the speed of at least one of the conveyor 115, the roller die rotational speed, and the drum rotational speed. When the roller die 125 and drum 130 rotate at substantially the same speed, the dimensions of the green rubber strip S will not substantially change when the strip is applied to the drum 130. However, when the drum 130 rotates at a higher speed then the roller die 125, the speed differential will cause the green rubber strip S to stretch as it is applied to the drum 130. This stretching will cause the green ribbon tread 305 to have a reduced height. By contrast, when the roller die 125 rotates at a higher speed than the drum 130, the speed differential will cause the green rubber strip S to compress (or be negatively stretched) as it is applied to the drum 130. This compression will cause the green ribbon tread 305 to have a reduced height.

In one embodiment, the controller 150 creates the speed differential between the roller die 125 and the drum 130 by varying the rotational speed of the roller die 125 while maintaining the rotational speed of the drum 130 at a constant rate. For example, the rotational speed of the applicator wheel 140 of the roller die 125 may be varied while the rotational speed of the drum 130 is maintained at a constant rate. In one such an embodiment, the applicator wheel 140 is driven by calender motors (not shown). In an alternative embodiment (not shown), the applicator wheel 140 is driven by a separate servo motor or cam system. A timing belt may also be employed. The use of a separate servo motor or cam system allows the applicator wheel 140 to be driven at higher speeds. In preliminary testing, the applicator wheel 140 has been driven at feed rates between 10 kilograms per minute and 15 kilograms per minute when driven by calender motors. In additional testing, the applicator wheel 140 has been driven at feed rates between 10 kilograms per minute and 40 kilograms per minute when driven by separate servo motors.

In an alternative embodiment, the controller 150 creates the speed differential between the roller die 125 and the drum 130 by varying the rotational speed of the drum 130 while maintaining the rotational speed of the roller die 125 at a constant rate. In another alternative embodiment, the controller 150 creates the speed differential between the roller die 125 and the drum 130 by varying the rotational speeds of both the roller die 125 and the drum 130.

In one embodiment, the controller 150 varies the rotational speeds of at least one of the roller die 125 and the drum 130, such that the rotational speed of the drum 130 is between 0.5 times the rotation speed of the roller die 125 and 1.5 times the rotation speed of the roller die 125. As a result, the rubber strip S is applied to the drum 130 at a rate between 10 kilograms per minute and 40 kilograms per minute. However, it should be understood that any rotational speeds and any feed rate may be employed.

The controller 150 controls the rotational speeds of the roller die 125 and the drum 130 in such a manner that a first peak on a first portion of the green rubber strip S is adjacent a second peak on a second portion of the green rubber strip S that overlaps the first portion. Additionally, the controller 150 controls the rotational speeds of the roller die 125 and the drum 130 in such a manner that a first valley on a third portion of the green rubber strip S is adjacent a second valley on a fourth portion of the green rubber strip S that overlaps the third portion.

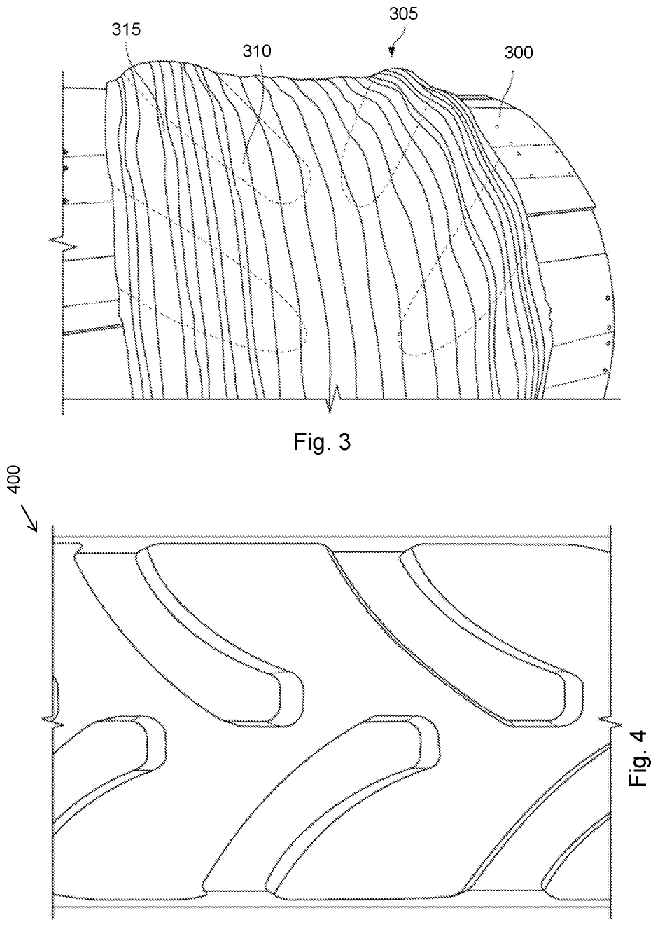

In one embodiment, the controller 150 controls the rotational speeds of the roller die 125 and the drum 130 so that peaks and valleys are formed that correspond to lug forming portions of a tire mold. For example, FIG. 4 illustrates a top plan view of an exemplary tread design 400 of a tire. The peaks 310 and valleys 315 of the green ribbon tread 305 correspond to the lugs of the tread design 400. As one of ordinary skill in the art would understand, increasing the similarity between peaks 310 and valleys 315 of the green ribbon tread 305 and the mold features will help to reduce rubber flow in the curing press. However, the shape of the green tread elements may depart from the geometry of a cured tread.

In one specific embodiment, the peaks 310 and valleys 315 of the green ribbon tread 305 generally correspond to a tread negative by occupying at least 40% of a cured tire's void and tread element volume. In another embodiment, the peaks 310 and valleys 315 of the green ribbon tread 305 generally correspond to larger voids in a tread. In this embodiment, the peaks 310 and valleys 315 of the green ribbon tread 305 generally correspond to the larger voids in a tread by occupying at least 30% of the cured tire's void volume. In another embodiment, the peaks 310 and valleys 315 of the green ribbon tread 305 closely correspond to the larger voids in a tread by occupying at least 80% of the cured tire's void volume.

In one embodiment, the thickness of the green ribbon tread 305 at a peak 310 is between 50% and 100% greater than the thickness of the green ribbon tread 305 at a valley 315. In one particular embodiment, the thickness of the green ribbon tread 305 at a peak 310 is between 60% and 80% greater than the thickness of the green ribbon tread 305 at a valley 315. In one known example, a thickness of the green ribbon tread 305 at a peak 310 is between 5 centimeters and 20 centimeters, and a thickness of the green ribbon tread 305 at a valley 325 is between 1 centimeter and 5 centimeters. As one of ordinary skill would understand, increased height of the peaks 310 is desirable for deep mold lugs because it would require less rubber movement during vulcanization. Additionally, using less rubber in the valleys 315 reduces the weight of the tire.

In one particular embodiment, the tread design is designed for use on an agricultural tire or off road tire. In this embodiment, the height of each lug is approximately 6% of the tire's width. In additional embodiments, the height of each lug is between 3-8% or 4-7% of the tire's width. In further embodiments, the height of each lug is between 6-35% of the tire's width. However, it should be understood that the lugs may have any height.

As one of ordinary skill in the art would recognize, the tread design may be used in agricultural tire constructions designated as R1, R1W, and R2 constructions, where R1 corresponds to a standard skid depth (Tire & Rim Association Standard AG-09-21), R1W corresponds to a skid depth that is 20% deeper than R1, and R2 corresponds to a skid depth that is 200% of R1. Additional examples of tires utilizing skids include, without limitation, drive wheels for agricultural vehicles, irrigation tires, forestry tires, floatation tires, combine tires, tractor tires, mining tires, construction tires, sprayer tires, and off-the-road vehicles.

In the illustrated embodiment, the drum 300 is a collapsible drum. After the green ribbon tread 305 is completed, the drum 300 is collapsed so that the green ribbon tread 305 can be removed and then placed around a tire carcass (not shown) to form a green tire. The green ribbon tread 305 may be formed at a first location and transported to a second location to be placed on the tire carcass. In an alternative embodiment, the green ribbon tread 305 is cured or partially cured prior to being placed on a tire carcass.

The tire carcass includes a pair of annular beads configured to secure the tire to a wheel. The tire carcass further includes at least one body ply extending between the annular beads. The tire carcass also includes a circumferential belt configured to provide structural reinforcement to the tire.

In one particular embodiment, the green ribbon tread 305 is stitched in place on the tire carcass with a stitching roller (not shown). The stitching roller may have voids corresponding to the peaks 310 of the green ribbon tread 305.

The green tire is then placed in a vulcanization mold. The vulcanization mold includes a tread forming portion that imparts tread elements onto the tire. For example, the vulcanization mold may include a tread forming portion for an agricultural tire or off road tire that includes voids for forming lugs (or bars) on the tread, and protrusions for forming valleys between the lugs. The green tire is oriented in the vulcanization mold such that the peaks 310 of the green ribbon tread 305 are aligned with voids in the tread forming portion of the mold. During curing of the green tire, rubber flows into voids of the vulcanization mold. However, because of the alignment of the peaks 310 of the green ribbon tread 305, less rubber needs to flow into the voids compared to a smooth green tread.

As one of ordinary skill in the art will appreciate, the methods and constructions described in this disclosure will increase yield. For instance, reducing the volume between the green tire and the mold features may help improve yield because it reduces rubber flow and resulting gauge variation (such as belt wave) in various reinforcing structures. The methods and constructions described in this disclosure may reduce gauge variation and/or belt wave, particularly in large tires and agricultural tires, where portions of the belt have been known to migrate toward a lug during vulcanization.

Likewise, the methods and constructions described in this disclosure may improve cord distortion and improve tire appearance. The methods and constructions described in this disclosure may also allow for rubber savings. For example, the methods and constructions described herein may require between approximately 10-20% less material and result in a tire having 20% less weight.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the disclosure, in its broader aspects, is not limited to the specific details, the representative system and method, and illustrative examples shown and described. Accordingly, departures may be made from such details without departing from the spirit or scope of the applicant's general inventive concept.

What is claimed is:

1. A method of manufacturing a tire tread comprising:
extruding a rubber strip;
conveying the rubber strip to a roller die that rotates about a roller die axis;
applying the rubber strip from the roller die onto a drum that rotates about a drum axis, wherein the drum axis is substantially parallel to the roller die axis;
translating the roller die in a first direction parallel to the roller die axis while applying the rubber strip, thereby forming a spiral of the rubber strip about the drum; and
varying a rotation speed of at least one of the roller die and the drum while translating the roller die, thereby creating positive or negative stretch in the rubber strip such that peaks and valleys are formed in the spiral of the rubber strip about the drum.

2. The method of claim 1, wherein the varying the rotation speed of at least one of the roller die and the drum is controlled by a computer, and wherein the peaks and valleys are formed such that they correspond to lug forming portions of a tire mold.

3. The method of claim 1, wherein the varying the rotation speed of at least one of the roller die and the drum includes varying the rotation speed of only the roller die.

4. The method of claim 1, wherein the varying the rotation speed of at least one of the roller die and the drum includes varying the rotation speed of only the drum.

5. The method of claim 1, further comprising translating the roller die in a second direction opposite to the first direction while applying the rubber strip, thereby forming a second layer of rubber over the spiral of the rubber strip about the drum.

6. The method of claim 1, wherein the rotation speed of the drum is between 0.5 times the rotation speed of the roller die and 1.5 times the rotation speed of the roller die.

7. The method of claim 1, wherein the rubber strip is applied to the drum at a rate between 10 kilograms per minute and 40 kilograms per minute.

8. An system for making a tire tread comprising:
an extruder;
a roller die having a first axis of rotation;
a conveyor having a first end proximate to the extruder and a second end proximate to the roller die, such that it receives a strip of green rubber extruded by the extruder and feeds the strip of green rubber to the roller die;
a drum having a second axis of rotation,
wherein the roller die is configured to apply the strip of green rubber to the drum; and
a controller,
wherein the controller is configured to control a translation of the roller die in a first direction parallel to the first axis of rotation, and
wherein the controller is configured to control a roller die rotation speed and a drum rotation speed, and wherein the controller varies at least one of the roller die rotation speed and the drum rotation speed during translation of the roller die.

9. The system of claim 8, wherein the roller die includes a pair of shaping rollers.

10. The system of claim 8, further comprising at least one rail extending parallel to the first axis of rotation, wherein the roller die is configured to translate along the at least one rail.

11. The system of claim 8, wherein the drum is a collapsible drum.

12. The system of claim 8, wherein the roller die includes a stitching roller, wherein the stitching roller is configured to press the applied strip of green rubber onto the drum.

13. The system of claim 8, wherein the controller is configured to control the roller die rotation speed and the drum rotation speed such that peaks and valleys are formed that correspond to lug forming portions of a tire mold.

14. A green tire tread comprising:
a strip of green rubber having a first edge and a second edge,
wherein the strip of green rubber is wound about in a spiral, such that the first edge overlaps the second edge,
wherein a thickness of the strip of green rubber varies along the strip, such that the strip of green rubber has peaks and valleys,
wherein a first peak on a first portion of the strip of green rubber is adjacent a second peak on a second portion of the strip of green rubber that overlaps the first portion, and
wherein a first valley on a third portion of the strip of green rubber is adjacent a second valley on a fourth portion of the strip of green rubber that overlaps the third portion.

15. The green tire tread of claim 14, wherein a thickness of the strip of green rubber at the first peak is between 5 centimeters and 20 centimeters.

16. The green tire tread of claim 14, wherein a thickness of the strip of green rubber at the first valley is between 1 centimeter and 5 centimeters.

17. The green tire tread of claim 14, further comprising a second layer of green rubber disposed over the strip of green rubber.

18. The green tire tread of claim 17, wherein the second layer of green rubber is a second strip of green rubber.

19. The green tire tread of claim 17, wherein the second layer of green rubber is formed by winding the strip of green rubber back over itself.

20. The green tire tread of claim 14, wherein the green tire tread is disposed on a green tire.
